(19) United States
(12) Patent Application Publication
(10) Pub. No.: US 2023/0367623 A1
(43) Pub. Date: Nov. 16, 2023

(54) METHOD AND MOTOR VEHICLE CONTROLLER FOR OPERATING A CONTAINER VIRTUALIZATION WITH LOGGING FUNCTION, AS WELL AS COMPUTER-READABLE STORAGE MEDIUM

(71) Applicant: CARIAD SE, Wolfsburg (DE)

(72) Inventors: Jithin Reju, Bochum (DE); Marc Deharde, Dortmund (DE); Matthias Priebe, Dortmund (DE); Timo Lange, Bochum (DE)

(21) Appl. No.: 18/311,132

(22) Filed: May 2, 2023

(30) Foreign Application Priority Data
May 11, 2022 (DE) 102022111836.3

(51) Int. Cl. G06F 9/455

(52) U.S. Cl. CPC G06F 9/45558; G06F 2009/45575

(57) ABSTRACT

A method of container virtualization in a processor circuit is provided, wherein the processor circuit operates a host operating system and at least one container in which application software is implemented. The processor circuit operates a logging service of the host operating system independently of the at least one container. The at least one container or the application software is coupled by a data channel to the host operating system. The application software outputs at least one message regarding an operation event of the application software in a first format into the data channel. A conversion unit is operated in the host operating system which receives the at least one message from the data channel and converts it from the first format into a host-specific second format, and transfers the converted message to the logging service for logging of the operation event.

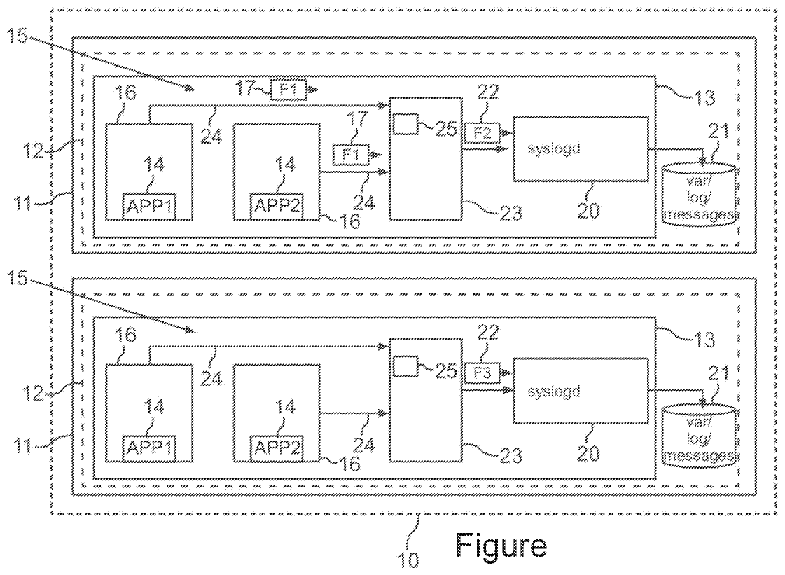

### BACKGROUND

### Technical Field

The disclosure relates to a method for operating a container virtualization in a processor circuit, such as may be provided for example in a controller of a motor vehicle. By way of a container virtualization it is possible, in a shared host operating system, to run application software separately from each other, such that each application software is executed in its own file system, which is kept in storage in a respective data container. Such a data container is also known simply as a container or image. Despite the isolating of the respective application software in a container, it should be possible for the application software to make use of the operating system's own logging service, such as can be operated for example for an error logging. The disclosure also relates to a motor vehicle controller, which can carry out a container virtualization by way of a processor circuit, as well as a computer-readable storage medium in order to implement the method according to the disclosure on a processor circuit.

### Description of the Related Art

An operating system can operate a logging service during its operation in order to gather messages on operation events in the respective application software and store them in a common log file. One example of such a logging service is the logging service syslogd for the operating system Unix or Linux, which can utilize for example the file /var/log/messages (a fixed filename, independent of the language of the operating system, in German /var/log/messages). Depending on the operating system or operating system variant, the format in which messages of application software need to be sent to the logging service will differ.

The described container virtualization makes it possible for an application software to bring together all needed files, such as library files (DLL—dynamic link library) and/or configuration files, in one data container, so that it can be assured that the application software will find all files in the correct version when the application software is executed on an operating system. Such an operating system which executes an application software in such a container shall be called a host operating system.

An application software executed in a container can only perform a file access to the file system provided for it within the container, that is, the file system is defined or dictated by the container, such as is made available to the application software by the host operating system. One advantage of such a container is that the application software can always be executed in the same file environment or file system environment predetermined by the container. Due to this independence of the file system of the host operating system, there is also increased interest in implementing a container also on different host operating systems.

Yet if the need exists for such an application software in a container to report or signal a message regarding an operation event, for example a runtime error, the application software but be capable of relaying to the logging service of the host operating system a message in the data format or the format which can be processed or which is demanded by the logging service. This limits the possibility of implementing a container on different host operating systems.

Examples of container virtualization are known from US 2019/010 22 38 A1. This describes how a data interchange between software within a container on the one hand and a surrounding runtime environment can take place through a port of a network interface. In order to adapt such a container for different application purposes, it is proposed to adapt program libraries in dependence on the corresponding configuration data when creating the container.

It is also known from US 2016/017 07 43 A1 how to put together an application software from different software fragments which are chosen in dependence on the planned usage environment of the software. Thus, a specific code must be generated for an application software for different application environments.

### BRIEF SUMMARY

Embodiments of the disclosure address how to adapt the use of containers in different host operating systems and the interaction with the particular host operating system with less expense in a container virtualization.

As one solution, the disclosure involves a method for operating a container virtualization in a processor circuit. The term “container virtualization” is to be understood as is known in the prior art, that an application software is executed within a so-called container (data container) by a host operating system and the application software is limited to the contents of the container in respect of access to the file system. Thus, the virtualization refers to the file system access, but application software from different containers utilize the same host operating system. This is operated in a known manner according to the method by the processor circuit and at least one container with a respective application software implemented by way of the host operating system. The method in addition presumes that a logging service of the host operating system is implemented independently of the at least one container. This can be, for example, the above described service “syslogd,” but the host operating system can also be a variant of a Unix operating system or Posix operating system, for example.

Now, in order to make it possible for an application software to interact with the logging service of the host operating system regardless of the format which the messages need to have for the logging service in the present host operating system, it is proposed according to the disclosure that the respective container and/or the application software executed in the container is coupled by a data channel to the host operating system. Thus, within the container, the application software can enter data in the data channel or send data out. Accordingly, the application software puts out at least one message regarding a particular operation event of the application software in a first format in the data channel. The application software can thus be developed or written or programmed such that it composes its messages on operation events in a first format, for example, a format which is prescribed for a particular host operating system or a particular operating system variant. In general, the first format is application-specific in that the application software uses this first format to generate its messages. Such messages can be, for example, warnings or runtime errors. In the host operating system, outside of the at least one container, thus for example in the host's own file system, a conversion unit or interpreter unit is operated. This can be operated or designed for example as an application software or an operating system routine or as a so-called daemon or background service or as a plugin for another software.

This conversion unit receives the particular message from the data channel and converts the message from the first format to a predetermined host-specific second format. This second format is the one in which messages need to be composed for the logging service of the host operating system in order to be processed or accepted by the logging service. For this reason, it is termed “host-specific”. Another terminology is platform-specific, if one wishes to call the host operating system a platform or container platform for implementing the at least one container with its application software. Another terminology is also an operating system-specific second format. In particular, the first format and the second format are different. In other words, the arrangement of the data and/or the data contents of the message need to be converted or changed in order to convert from the first format to the second format. The converted message (in the second format) is transferred by the conversion unit to the logging service for the logging of the operation event.

Thus, operation events of the application software during the execution in its container can still be logged by the host operating system, and this with the operating system's own or host-specific logging service. For example, the logging service can keep a so-called log file for saving the messages, such as can be created in Unix variants in the file folder /var/log/, such as the file /var/log/messages. The container with the application software can be operated on different host operating systems without the application software needing to be changed or adapted in relation to the format of its messages on operation events, that is, the application software can always put out messages in the first format through the data channel to the host operating system. In the respective host operating system, a respective host-specific conversion unit or translation unit will be operated, which converts the received format into the host-specific second format and transfers the messages so converted to the logging service of the host operating system. Since each host operating system being used is outfitted with its own host-specific conversion unit (which can put out messages in the second format), a container with an application software can be operated on different host operating systems with no additional expense for adapting it.

The disclosure also involves further developments or modification the features of which produce additional advantages.

In order to transfer messages of the application software out from its container to the host operating system, the above described data channel is proposed. According to one further development, the data channel comprises one or more of the following components of the host operating system:
a standard output, STDOUT,
a standard error output, STDERR,
a port of a network interface of the host operating system, Socket,
a system call, Syscall,
an interprocess communication, IPC, especially a Shared Memory and/or a Pipe.

The standard output STDOUT and the standard error output STDERR are data channels which can be provided to an application software during its execution for the runtime by the host operating system. On such a data channel STDOUT and STDERR, an application software can be accessed by a corresponding operating system call (Syscall), for example by using the C function prentf in the context of or by way of the library libc, to give only one example for the implementing of a transfer of a message in the data channel of the standard output or standard error output. By way of the standard output and the standard error output, the application software can send its message, e.g., directly to the kernel of the operating systems (OS kernel), which can then be passed on to the conversion unit. In this way, an especially efficient inter-process communication results. As the data channel, a port of a network interface of the host operating system can also be provided in the previously described manner, that is, the application software can communicate with the host operating system via a so-called socket through a network, where for example the socket can be uniquely identified by an IP address (IP=internet protocol) and a port number. The data channel may also include a system call, a so-called System Call or Syscall, in order to transfer the message or the message data directly to the operating system. It is also possible to provide an interprocess communication, IPC, in order to transfer the message for example by way of shared memory and/or a so-called pipe from the address space of the application software to the address space of the conversion unit. The described mechanisms all have the advantage that the messages can be transferred from the address space of the application software (the so-called user space of the application software) to another address space, so that they are available in the host operating system outside of the container or the container virtualization.

A further development involves the respective application software of several different applications being operated in one container or separately in multiple containers. One or more applications can be executed per container. Each application software of each of the applications generates its messages uniformly in the first format as host-independent standard format. In other words, it can be provided when developing the application software that each application software which is developed generates messages for the logging service of the host operating systems executing it in the first format. The particular host operating system then converts the messages with its host-specific conversion unit into the host-specific second format, where different host operating systems can have different second formats. Thus, there is no need when developing the application software to already be aware of the second format. Instead, the application software can be uniformly developed or executed such that messages on operation events in a first data format are put out or sent to a data channel.

A further development involves the conversion unit having a parser, i.e., a data scanner or data checker, which parses or scans data transferred in the data channel by a predetermined message pattern or compares the data with the message pattern, which is characteristic of messages which are composed in the first format. The parser thus recognizes, among the data or in the data transferred via the data channel, all the data belonging to a respective message in the first data format. Other data, not being data in the first format, are the ignored by the parser. Thus, data without the message pattern are ignored in the data channel. Data with the message pattern or having the message pattern are read as messages to be converted (in the first format) and are converted by the conversion unit in the described manner. This yields the advantage that the data channel can also be used to carry other data not representing messages in the first format. The conversion unit only responds to those messages which constitute messages to be converted, which is identified by way of the parser and the message pattern.

A further development involves the conversion unit being provided as a plugin for an operating software of the respective container. Such operating software can be executed by the host operating system in order to operate or hold the application software in its container. The operating software for the container routes the data received from the container via the data channel through the plugin. A plugin can be configured for example as a DLL (Dynamic Link Library) or Shared Object (.so). It can be coupled to the operating software by an API (Application Programming Interface). The operating software can be adapted such that, when the plugin is attached or connected, these data being transferred via the data channel from the application software to the operating software will first be relayed to the plugin before the data are routed further. Thus, the respective message in the first format can be read or filtered from the data in the plugin. The rest of the data can be relayed by the operating software to other recipient software, for example, to a monitor screen output for display of the data on a monitor screen which is operated by the host operating system.

The term “logging service” used here can involve at least one of the following. A logging (for recording of status messages and/or warning messages and/or error messages), a diagnostics (for checking the operational status of the application software), a status monitoring (health analysis), a privacy management (for protection of personal data of a user being used by the application software). The logging service for example can be operated as a logging service or operating system-wide logging or as a watch dog or OBD (on board diagnosis) in the case of implementing the method in a motor vehicle.

A further development involves multiple different logging services being operated in the host operating system and for each of the logging services there is operated its own conversion unit for converting of messages addressed to the logging service into the particular host-specific and service-specific format required by the logging service. Thus, there need not be present only a single logging service in the host operating system, but instead multiple logging services can be operated, such as a logging and a diagnostics. The application software can then send different messages to different logging services and each logging service can convert by way of its conversion unit the messages generated by the application software into the format required by the logging service.

According to a further development, it is proposed that at least one further container in addition to the already described container, with respective application software, is implemented or operated on the host operating system or on at least one further host operating system. Thus, at least two host operating systems are in operation, for which the same processor circuit or also several different processor circuits can be used, as is known in itself from the prior art. The application software in the particular container or the several applications with their application software in the respective container can send out messages to the different host operating systems from their container via the respective data channel. Of course, each application software will send messages via the channel of that host operating system on which it is being executed to the host operating system on which it is being executed. Each host operating system operates its own logging service for messages. However, the logging services are able to receive messages in different formats, that is, in addition to the logging service which requires the described second format for messages and which is executed on the already described host operating system, a logging service is operated on at least one further host operating system for messages in a third format, differing from the second format and from the first format. This further host operating system then has a corresponding further conversion unit for converting the messages from the data channel of this host operating system to the third format. In particular, it is provided that the containers are copies of a common container template, that is, the application software in the respective container is identically configured and generates its messages in said first format. Even so, the respective copy of this container template can be operated on another host operating system and logging is possible through the respective host-specific logging service.

For application cases or situations which may occur during the method and which are not described here explicitly, it can be provided according to the method that an error message and/or a prompt to enter a user feedback is put out and/or a standard setting and/or a given initial status will be set.

In particular, this is advantageous in connection with the use of containers in motor vehicle controllers (ECU—Electronic Control Unit). Thus, an application software can be provided in a container which is implemented by way of container virtualization on a motor vehicle controller, the host operating system of which need not be taken into account when developing the application software in regard to the format of messages for the logging service of this host operating system. Accordingly, the disclosure involves, as a further solution for the aforementioned problem, a motor vehicle controller to implement at least one container of a container virtualization. The controller comprises said processor circuit, which is adapted to carry out one embodiment of the method according to the disclosure. In particular, it is provided that copies of a container template with an application software are run on different controllers of a motor vehicle, each of them providing a different host operating system to carry out the container virtualization, i.e., the operation of the container.

As a further solution, the disclosure also involves a computer-readable storage medium, containing commands which when executed by a computer or a computer grouping make it carry out an embodiment of the method according to the disclosure. The storage medium can be configured, e.g., at least partly as a nonvolatile data storage (such as a flash memory and/or a SSD—solid state drive) and/or at least partly as a volatile data storage (such as a RAM—random access memory). The storage medium can be realized in the processor circuit in its data storage. But the storage medium can also be operated for example as a so-called appstore server on the Internet. The computer or computer grouping can provide a processor circuit with at least one microprocessor. The commands can be provided as binary code or assembler and/or as source code of a programming language (such as C).

In order to enable a processor circuit, especially one of a motor vehicle controller, to carry out the method, the disclosure also relates to a computer-readable storage medium with program instructions which is adapted, when executed by a processor circuit, to make it carry out the embodiment of a method according to the disclosure.

A motor vehicle containing or comprising at least one embodiment of the motor vehicles according to the disclosure is likewise to be seen as being part of the disclosure. In other words, the disclosure also involves a motor vehicle having at least one motor vehicle controller, respectively representing one embodiment of the motor vehicle controller according to the disclosure. The motor vehicle according to the disclosure is preferably designed as an automobile, especially as a passenger car or truck, or as a personal bus or motorcycle.

The disclosure also encompasses combinations of the features of the described embodiments. Thus, the disclosure also encompasses realizations comprising a combination of the features of several of the described embodiments, as long as the embodiments were not described as being mutually exclusive.

### BRIEF DESCRIPTION OF THE SEVERAL VIEWS OF THE DRAWINGS

In the following, exemplary embodiments of the disclosure are described. For this, the sole FIGURE shows a schematic representation of one embodiment of a motor vehicle having two controllers.

In the exemplary embodiments, the components described for the embodiments each constitute individual features of the disclosure to be viewed independently of one another, and which modify the disclosure independently of one another. Therefore, the disclosure will also encompass other than the represented combinations of features of the embodiments. Furthermore, the described embodiments can also be supplemented by further of the already described features of the disclosure.

The FIGURE shows a motor vehicle 10, which can be an automobile, especially a passenger car or truck. Controllers 11 can be provided in the motor vehicle 10, such as are provided for example for a driver assist functionality and/or an infotainment (information and entertainment) and/or an engine control system, to mention only some examples. Each controller 11 can be outfitted in the manner described below, so that the description here is limited to a single controller 11.

The particular controller 11 can be provided as a so-called embedded device or embedded control circuit. A processor circuit 12 can be provided in the controller 11, by which a host operating system 13 can be implemented or operated. The operating system 13 can be implemented, for example, on one or more microprocessors and/or microcontrollers and/or SoCs (System on Chip). The operating system 13 can be, for example, an embedded operating system and/or a Unix operating system or Linux operating system. The operating system 13 can operate or execute one or more applications APP1, APP2, by which respective vehicle functionalities can be provided in the motor vehicle 10. A respective application software 14 of the applications APP1, APP2 can be executed by way of a container virtualization 15 such that the two applications APP1, APP2 cannot influence each other through their file systems, for example, by accidentally or deliberately falsifying or deleting application files of the other application. For this, each application software 14 is provided by way of the container virtualization 15 in a container 16, which can be provided or configured for example according to the OCI (open container initiative) standard. By way of a container 16, the respective application software 14 can be provided with a file system, which the application software 14 can access during its execution at the runtime. The access is limited to this file system in the container 16 during the container virtualization 15, such as is known.

However, in the operating system 13 there is possible a container-overarching or container-external logging of messages 17 which can be generated by the particular application software 14 in regard to operation events during the runtime of the particular application software 14. For this, in a manner known in itself, the operating system 13 can operate a logging service 20, which is implemented outside of the container 16 and which can also keep track of messages from applications of the operating system 13 which are operated outside of the container. The messages can be collected for example in a data storage 21. It is known from the field of Unix operating systems that a logging service 20 can be operated as a so-called daemon with the designation syslogd. One possible file for the collection of messages 17 in this regard is the file /var/log/messages. But these are examples of names of a logging service and a logging file.

The messages 17 of the respective application software 14 from the containers 16 can be composed or formatted in a format F1, which can be for example a common standard format for each application software 14 in containers 16 in the motor vehicle 10. A manufacturer of the controllers 11 can thus configure or program its application software 14 uniformly, such that messages 17 for logging services 20 are written in the first format F1. However, the logging services 20 in the controllers 11 may be different, on account of different operating systems 13. A logging service 20 may require that the messages 22 relayed or sent or supplied to it, which can or should be kept track of in the data storage 21, should be drafted or written in a second format F2 or a third format F3. For example, the formats F1, F2, F3 may differ in which so-called log-level should be associated with a message or an operation event and/or in which data format the messages are composed in, such as JSON or XML, and/or in which designation the data elements of the message have.

Yet in order to operate the containers 16 flexibly on different controllers 11 with different operating systems 13, a conversion unit 23 can be operated for the container virtualization 15 in the respective operating system 13, to which the messages 17 of the application software 14 of the respective applications APP1, APP2 are routed.

For this, each application software 14 in its container 16 can be connected or coupled by a data channel 24 to the environment outside the container 16. The data channel 24 can be realized for example as a data stream, such as is known as STDOUT or STDERR in operating systems, for example. For this, it can be provided for example that the access to the respective data stream 24 is provided as a so-called file descriptor of the application software 14. The data channel in its embodiment as a file descriptor can be inserted by the operating system 13 for example in the file system of the container 16, i.e., as a virtual file, which can be opened by the application software 14, so that the file descriptor is made available. However, in this case, it is not a file in the container 16, but rather a pseudofile or virtual file, so that when writing or saving data of the message 17 in this file descriptor the data go from the address space of the application software 14 to the address space of the operating system 13 or to the address space of the operating software for the respective container 16 and from here the data can be handed over to the conversion unit 23. The conversion unit 23 can be implemented, for example, as a software or as a plugin or operating system service function.

The operating system 13 can receive the data saved by this data descriptor in the data channel 24, for example as STDOUT or STDERR, and transfer them to the conversion unit 23. For this, the conversion unit 23 can be configured for example as a plugin for a driver software or an operating software for the container 16. In the conversion unit 23, a parser 25 can be implemented, for example, which parses data from the respective data channel 24 of each container 16 and identifies whether a message in the first format F1 is contained or relayed therein. For this, the conversion unit 23 can be configured or adapted to convert messages in format F1 into messages in format F2 and/or F3, i.e., into a format which is needed for the logging service 20 of the operating system 13. A correspondingly provided conversion unit 23 must be installed in the operating system 13 for this. But this can then be used for all containers 16.

If a message 17 has then been converted from format F1 into format F2 or F3, it can be routed as a converted message 22 to the logging service 20 of the operating system 13. Thus, from the perspective of the logging service 20, a converted message 22 can thus appear as if it was put out or generated by the conversion unit 23. The messages can be error messages or warning messages or status messages, for example.

Thus, one obtains an architecture in which multiple OCI (OCI—open container initiative) containers can run on different target hardware. The idea is that the container will behave exactly the same during the logging on both devices. This is made possible by the logging interpreter (conversion unit), which abstracts the platform specifics from the container. This ensures that the developer does not have to bother with the architecture of the logging systems of the system or the like.

The sequence of the logging with the proposed architecture is in particular as follows:
1) The application running inside the container writes a log message in a known format (such as json, xml) to stdout: json, xml) in a defined structure. An example of such a format might look like the following: Json format: {“vb”: “<log level>”, “txt”: “<message>”}
2) The logging interpreter is a plugin for an OCI container runtime environment such as Docker log driver. The log driver consists of the API defined by Docker and a user-defined library, which detects and analyzes the received logging messages in the defined format before they are sent to the underlying logging system.

The user-defined libraries differ according to the underlying logging architecture of the operating system. The logging interpreter ensures that the log level of applications on different operating systems are consistent. Example: Debug is Log level 4 on OS_1 and Debug is Log level 1 on OS_2.

This make sure that the application in the container is able to route the logs to the logging system without changing the source code, regardless of the hardware on which it is running. Since a known format (json, xml) is used in order to define the structure of a log message, a parser is available in each programming language and makes the implementation easy in every application. The described abstraction can also be used for other software components in automotive operating systems, such as diagnostics, health management, data protection management. That is, a diagnostics interpreter, health interpreter, and data protection interpreter will then be obtained.

On the whole, the examples show how an abstraction layer can be provided for a logging of a container virtualization on different operating systems.

German patent application no. 10 2022 111 836.3, filed May 11, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method of container virtualization in a processor circuit, the method comprising:
operating, by the processor circuit, a host operating system; and
operating, by the processor circuit, at least one container in which application software is implemented; and
wherein the processor circuit operates a logging service of the host operating system independently of the at least one container,
wherein the at least one container or the application software implemented in the container is coupled by a data channel to the host operating system,
wherein the application software outputs at least one message regarding an operation event of the application software in a first format into the data channel,
wherein a conversion unit is operated in the host operating system,
wherein the conversion unit receives the at least one message from the data channel and converts the at least one message from the first format into at least one converted message having a host-specific second format, and transfers the at least one converted message to the logging service, and
wherein the logging service logs the operation event.

2. The method according to claim 1, wherein the data channel includes one or more of:
a standard output, STDOUT, of the host operating system,
a standard error output, STDERR, of the host operating system,
a port of a network interface of the host operating system, Socket,
a system call, Syscall, of the host operating system, or
an interprocess communication, IPC, of the host operating system that transfers the at least one message using a Shared Memory or a Pipe.

3. The method according to claim 1, wherein the application software is for a plurality of applications operated in the at least one container,
wherein the at least one message includes a plurality of messages respectively generated by the plurality of applications,
wherein each of the plurality of messages is generated in the first format as a host-independent standard format, and
wherein the conversion unit converts the plurality of messages into the host-specific second format.

4. The method according to claim 1, wherein the conversion unit includes a parser which parses data transferred in the data channel by a message pattern that is characteristic of the at least one message in the first format, and
wherein the parser ignores data without the message pattern in the data channel and converts data with the message pattern as the at least one converted message.

5. The method according to claim 1, wherein the conversion unit is provided as a plugin for operating software of the at least one container, and
wherein the operating software routes data received from the at least one container via the data channel through the plugin.

6. The method according to claim 1, wherein the logging service performs at least one of: logging, diagnostics, status monitoring, or privacy management.

7. The method according to claim 1, wherein the logging service includes a plurality of logging services,
wherein the conversion unit includes a plurality of conversion units respectively corresponding to the plurality of logging services,
wherein the at least one message includes a plurality of messages, and
wherein each of the plurality of conversion units converts one of the plurality of messages addressed to one of the logging services into a particular host-specific and service-specific format required by the one of the logging services.

8. The method according to claim 1, further comprising:
operating, by the processor circuit or a further processor circuit, a further host operating system,
wherein the further host operating system operates a further container with further application software and receives one or more messages of the further application software by a further data channel,
wherein the further host operating system operates a further logging service for one or more messages in a third format, and
wherein the further host operating system operates a further conversion unit that converts messages from the further data channel into the third format.

9. A motor vehicle controller that implements container virtualization, the controller comprising:
at least one processor circuit; and
at least one data storage coupled to the at least one processor circuit,
wherein the at least one processor circuit, in operation, operates a host operating system,
wherein the at least one processor circuit, in operation, operates at least one container in which application software is implemented,
wherein the at least one processor circuit operates a logging service of the host operating system independently of the at least one container,
wherein the at least one container or the application software implemented in the container is coupled by a data channel to the host operating system,
wherein the application software outputs at least one message regarding an operation event of the application software in a first format into the data channel,
wherein a conversion unit is operated in the host operating system,
wherein the conversion unit receives the at least one message from the data channel and converts the at least one message from the first format into at least one converted message having a host-specific second format, and transfers the at least one converted message to the logging service, and
wherein the logging service logs the operation event in the at least one data storage.

10. A non-transitory computer-readable storage medium with program instructions which, when executed by a processor circuit, causes the processor circuit to:
operate a host operating system; and
operate at least one container in which application software is implemented; and
wherein the processor circuit operates a logging service of the host operating system independently of the at least one container,
wherein the at least one container or the application software implemented in the container is coupled by a data channel to the host operating system,
wherein the application software outputs at least one message regarding an operation event of the application software in a first format into the data channel,
wherein a conversion unit is operated in the host operating system,
wherein the conversion unit receives the at least one message from the data channel and converts the at least one message from the first format into at least one converted message having a host-specific second format, and transfers the at least one converted message to the logging service, and
wherein the logging service logs the operation event.
